(19) United States
(12) Patent Application Publication
(10) Pub. No.: US 2024/0311253 A1
(43) Pub. Date: Sep. 19, 2024

(54) INFORMATION PROCESSING SYSTEM, NON-TRANSITORY COMPUTER READABLE MEDIUM AND INFORMATION PROCESSING METHOD

(71) Applicant: FUJIFILM BUSINESS INNOVATION CORP., Tokyo (JP)

(72) Inventor: Satoshi TAKAHASHI, Kanagawa (JP)

(73) Assignee: FUJIFILM BUSINESS INNOVATION CORP., Tokyo (JP)

(21) Appl. No.: 18/450,754

(22) Filed: Aug. 16, 2023

(30) Foreign Application Priority Data
Mar. 14, 2023 (JP) 2023-039209

(51) Int. Cl. G06F 11/14; G06F 3/12

(52) U.S. Cl. CPC G06F 11/1438; G06F 3/121; G06F 3/1236; G06F 3/1288; G06F 2201/805

(57) ABSTRACT

An information processing system includes one or more processors configured to: if an error involving a restart occurs on an image processing apparatus remotely operated by a terminal having established communication, store error information including a cause of the error in a memory region before the restart; and if the communication is established again after an interruption of the communication caused by the restart, notify the terminal of the error information stored in the memory region.

### CROSS-REFERENCE TO RELATED APPLICATIONS

This application is based on and claims priority under 35 USC 119 from Japanese Patent Application No. 2023-039209 filed Mar. 14, 2023.

### BACKGROUND

### (i) Technical Field

The present disclosure relates to an information processing system, a non-transitory computer readable medium and an information processing method.

### (ii) Related Art

Japanese Patent No. 5983269 discloses a technique of remotely operating an image processing apparatus, such as a multi-function apparatus, printing and reading a document with a mobile terminal.

If such a remotely operated image processing apparatus disclosed in the technique is restarted because of an error, communication established between the mobile terminal and image processing apparatus may be suddenly interrupted. In such a case, the user of the mobile terminal may have difficulty in recognizing what happens.

### SUMMARY

Aspects of non-limiting embodiments of the present disclosure relate to helping the user of the mobile terminal recognize a reason of an interruption of communication between the mobile terminal and image processing apparatus if the communication between the mobile terminal and image processing apparatus is interrupted because of a restart of the remotely operated image processing apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including one or more processors configured to: if an error involving a restart occurs on an image processing apparatus remotely operated by a terminal having established communication, store error information including a cause of the error in a memory region before the restart; and if the communication is established again after an interruption of the communication caused by the restart, notify the terminal of the error information stored in the memory region.

### BRIEF DESCRIPTION OF THE DRAWINGS

Exemplary embodiments of the present disclosure will be described in detail based on the following figures, wherein:

FIG. 1 illustrates an example of an entire configuration of an information processing system of an exemplary embodiment;

FIG. 2 illustrates an example of a hardware configuration of an image processing apparatus;

FIG. 3 illustrates an example of a functional configuration of a controller of the image processing apparatus;

FIG. 4 illustrates an example of a functional configuration of a controller of a remote terminal;

FIG. 5 is a flowchart illustrating an example of a whole flow of a process of the image processing apparatus;

FIG. 6 is a flowchart illustrating an example of a whole flow of a process of the remote terminal;

FIGS. 7A through 7C illustrate specific examples of information displayed on a display of the remote terminal, wherein FIG. 7A illustrates a specific example of information displayed on the display of the remote terminal when the image processing apparatus is remotely operated, FIG. 7B illustrates a specific example of information displayed on the display when a connectivity of communication is verified by the remote terminal with the communication with the image processing apparatus interrupted, and FIG. 7C illustrates a specific example of error information that is transmitted from the image processing apparatus to the remote terminal when the communication is established again after the interruption of the communication; and

FIG. 8 illustrates a specific example of the error information stored in an error database in a storage of the image processing apparatus.

### DETAILED DESCRIPTION

Exemplary embodiments of the disclosure are described in detail with reference to the drawings.

### Configuration of Information Processing System

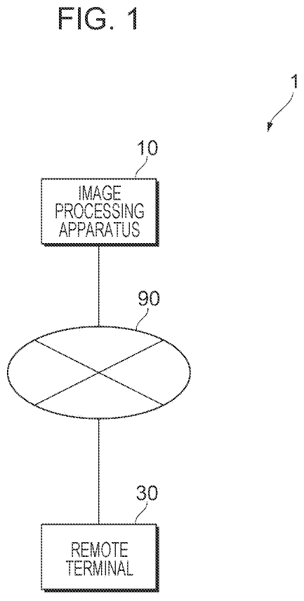

FIG. 1 illustrates an entire configuration of an information processing system 1 of an exemplary embodiment of the disclosure.

The information processing system 1 is constructed by connecting an image processing apparatus 10 and remote terminal 30 via a network 90. For example, the network 90 is a local-area network, the Internet or the like.

### Image Processing Apparatus

The image processing apparatus 10 is an information processing apparatus that performs a variety of operations in response to an input operation of a user using the information processing system 1. For example, the image processing apparatus 10 performs an operation of forming an image on a medium, such as a paper sheet, an operation of outputting a recording medium having an image formed thereon, an operation of reading an image formed on a paper sheet and other operations. The image processing apparatus 10 may be an electrophotographic multi-function apparatus that forms a toner image on a print surface of a paper sheet or an ink-jet printer that ejects ink onto a print surface of a paper sheet.

The image processing apparatus 10 acquires a variety of information from the remote terminal 30 and performs a variety of operations on the information. The image processing apparatus 10 also transmits a variety of information to the remote terminal 30. For example, the image processing apparatus 10 having communication established with and remotely operated by the remote terminal 30 detects the occurrence of an error that involves a restart and stores, before the restart, error information including a cause of the error on a database. If multiple errors occur during an interruption of the communication with the remote terminal 30, the image processing apparatus 10 stores in the database each piece of the error information associated with a priority. For example, the “error involving the restart” is an error that is caused by an on/off operation of a power supply of the image processing apparatus 10.

The communication may be established again when a connectivity verification of the communication is made after the remote terminal 30 detects an interruption of the communication caused by the restart. The image processing apparatus 10 then transmits to the remote terminal 30 the error information from the database. The image processing apparatus 10 transmits to the remote terminal 30 the error information that is determined as being a target to be transmitted in accordance with the priority associated with each piece of the error information. If no error information is stored in the database, the image processing apparatus 10 transmits to the remote terminal 30 information that indicates that the image processing apparatus 10 is force-disconnected from a power supply thereof.

The image processing apparatus 10 deletes or moves the error information from the database at a predetermined timing. For example, the image processing apparatus 10 deletes the error information at any timing that is after the error information is transmitted from the database to the remote terminal 30.

At any timing that is after the error information exceeds a predetermined storage period, a predetermined number of storage items or a predetermined amount of storage, the image processing apparatus 10 also deletes from the database an excess portion of the error information. Also, at any timing that is after storage of multiple pieces of the error information in the memory region is confirmed, the image processing apparatus 10 moves to another database for data accumulation the multiple pieces of the error information except a piece of the error information closest to the date and time of the occurrence of the error.

The image processing apparatus 10 stores in the database the error information associated with identification information uniquely identifying the remote terminal 30. For example, the identification information may be an Internet Protocol (IP) address of the remote terminal 30. The accuracy of identity determination of the remote terminal 30 is higher when the IP address of the remote terminal 30 is used as the identification information than when a user identity (ID) that may be shared by users is used.

When the image processing apparatus 10 establishes the communication again after the interruption of the communication caused by the restart of the image processing apparatus 10, the image processing apparatus 10 determines whether the identification information on the remote terminal 30 having established the communication is identical to the identification information on the remote terminal 30 associated with the error information. If the two pieces of the identification information are identical to each other, the image processing apparatus 10 transmits the error information to the remote terminal 30. In contrast, if the two pieces of the identification information are not identical to each other, the image processing apparatus 10 deletes the error information from the database. The process of the image processing apparatus 10 is described in detail below.

### Remote Terminal

The remote terminal 30 is a mobile information processing apparatus, such as a smart phone or tablet terminal, operated by a user of the information processing system 1. An application software program enabling the image processing apparatus 10 to be operated is installed on the remote terminal 30. The remote terminal 30 acquires a variety of information from the image processing apparatus 10 and performs a variety of operations. The remote terminal 30 transmits a variety of information to the remote terminal 30.

When an interruption of the communication with the image processing apparatus 10 is detected, the remote terminal 30 makes the connectivity verification of the communication with the image processing apparatus 10. While the connectivity verification of the communication with the image processing apparatus 10 is being made, the remote terminal 30 calculates an estimated time until the communication is established again and displays the calculated estimated time. In this case, for example, the remote terminal 30 calculates the estimated time in accordance with an actual value of time until the communication with the image processing apparatus 10 is established.

When the time of the connectivity verification of the communication with the image processing apparatus 10 exceeds a predetermined time duration, the remote terminal 30 ends the connectivity verification. Also, when the remote terminal 30 establishes the communication with the image processing apparatus 10 as a result of the connectivity verification, the remote terminal 30 transmits to the image processing apparatus 10 information indicating that the communication has been established. The image processing apparatus 10 identifies the remote terminal 30 having established the communication. The process of the remote terminal 30 is described in detail below.

The configuration of the information processing system 1 has been described for exemplary purposes only and the information processing system 1 may be acceptable as long as the functions implementing the processes described above are provided. Part or all of the functions implementing the processes may be performed by the internal elements in cooperation with each other or on a function-per-element basis in the image processing apparatus 10. Specifically, part or all of the functions of the remote terminal 30 may be the functions of the image processing apparatus 10 or part or all of the functions of the image processing apparatus 10 may be the functions of the remote terminal 30. Alternatively, part or all of the functions of each of the remote terminal 30 and image processing apparatus 10 forming the information processing system 1 may be transferred to another server (not illustrated). In this way, the processes of the whole information processing system 1 may be promoted and complement each other.

### Hardware Configuration of Image Processing Apparatus

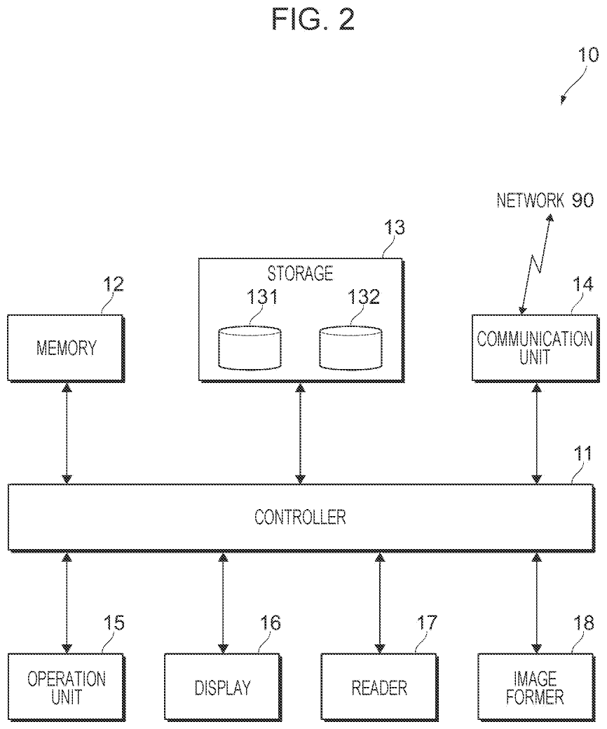

FIG. 2 illustrates an example of a hardware configuration of the image processing apparatus 10. The image processing apparatus 10 includes a controller 11, memory 12, storage 13, communication unit 14, operation unit 15, display 16, reader 17 and image former 18. These elements are interconnected to each other via a data bus, address bus or peripheral component interconnect (PCI) bus.

The controller 11 is a processor that controls the functions of the image processing apparatus 10 by executing a variety of software including an operating system (OS) and application software programs. For example, the controller 11 includes a central processing unit (CPU). The memory 12 serves as a memory region that stores the variety of software and data used to execute the software. The memory 12 serves as a work area in arithmetic operations of the controller 11. The memory 12 may include, for example, a random-access memory (RAM).

The storage 13 serves as a memory region that stores input data to the software and data output from the software. For example, the storage 13 includes a hard disk drive (HDD), solid-state drive (SSD) or semiconductor memory, each storing programs and a variety of setting data. The storage 13 stores, as databases storing a variety of information, an error database (DB) 131 and user DB 132 storing information related to users. The error information and user information are managed in an associated form.

The communication unit 14 exchanges data with the remote terminal 30 and the outside via the network 90. The operation unit 15 includes a software keyboard, physical button and switches and receives an input operation. The operation unit 15 includes a touch sensor that is integrated with the display 16 to form a unitary touch panel. The display 16 includes a liquid-crystal display or electroluminescence (EL) display, each used to display information and displays data, such as an image and text.

The reader 17 reads an image formed on a recording medium, such as a paper sheet (for example, a document on paper media). The reader 17 is a charge-coupled device (CCD) scanner that converges, with a lens, reflected light responsive to light emitted onto a document from a light source and receives the converged reflected light or a contact image sensor (CIS) scanner that receives reflected light responsive to light emitted onto a document from a light-emitting diode (LED) light source. For example, through an electrophotographic system or an ink-jet system, the image former 18 forms an image as a print target onto a print surface of a paper sheet as a recording medium. These elements are interconnected to each other via the data bus, address bus or PCI bus.

### Hardware Configuration of Remote Terminal

The hardware configuration of the remote terminal 30 is identical to the hardware configuration of the image processing apparatus 10 in FIG. 2 except the configuration of the reader 17 and image former 18. Specifically, the remote terminal 30 includes a controller, memory, storage, communication unit, operation unit and display that are respectively identical in configuration to the controller 11, memory 12, storage 13, communication unit 14, operation unit 15 and display 16 in FIG. 2 and the discussion thereof is omitted herein.

### Functional Configuration of Controller in Image Processing Apparatus

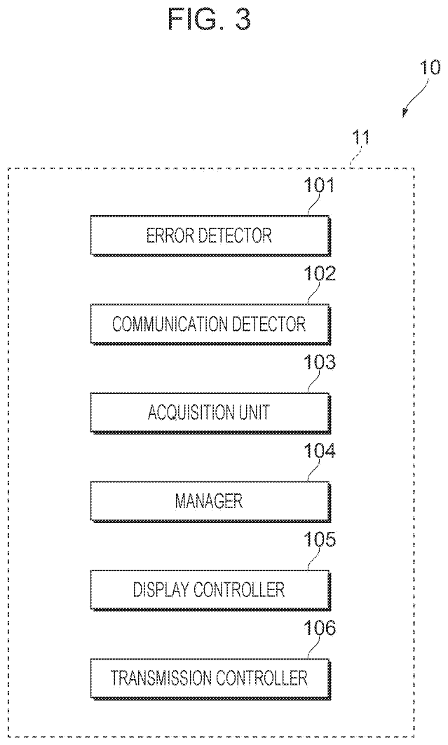

FIG. 3 illustrates an example of a functional configuration of the controller 11 in the image processing apparatus 10. The controller 11 in the image processing apparatus 10 includes an error detector 101, communication detector 102, acquisition unit 103, manager 104, display controller 105 and transmission controller 106.

The error detector 101 detects an error that involves a restart of the image processing apparatus 10.

The communication detector 102 detects an interruption of the communication with the remote terminal 30 caused by the restart of the image processing apparatus 10. The communication detector 102 also detects a re-establishment of the communication with the remote terminal 30.

The acquisition unit 103 acquires a variety of information. For example, the acquisition unit 103 acquires input information received through an input operation by the operation unit 15 (see FIG. 2). For example, the acquisition unit 103 also acquires a variety of information transmitted from the remote terminal 30 and the outside. Information transmitted from the remote terminal 30 out of information acquired by the acquisition unit 103 is information input to the remote terminal 30. The input information acquired by the acquisition unit 103 is information that is input to make a request for the error information.

The manager 104 stores a variety of information in the database of the storage 13 (see FIG. 2) and then manages the information. If the error detector 101 detects the occurrence of an error involving the restart on the image processing apparatus 10, the manager 104 stores on the error DB 131 the error information including the cause of the error and manages the error information before the restart. If multiple errors are detected with the communication with the remote terminal 30 interrupted, the manager 104 stores each piece of the error information associated with a priority on the error DB 131 and then manages the error information.

The manager 104 deletes or move the error information from the error DB 131 at a predetermined timing. For example, the manager 104 deletes the error information from the error DB 131 at any timing that is after the error information stored in the error DB 131 is notified to the remote terminal 30.

At any timing that is after the error information stored in the error DB 131 exceeds one of the predetermined storage period, the predetermined number of storage items and the predetermined amount of storage, the manager 104 deletes an excess portion of the error information from the error DB 131. If the predetermined amount of storage is exceeded, older error information may be overwritten using a ring buffer.

At any timing that is after the confirmation of multiple pieces of the error information on the error DB 131 is made, the manager 104 moves the multiple pieces of the error information except a piece of the error information closest to the date and time of the occurrence of the error to another database (not illustrated) for data accumulation. The manager 104 manages the error information such that the error information stored in the other database for data accumulation is referenced at any time.

The manager 104 manages the error information by associating the error information with the identification information on the remote terminal 30. If the communication with the remote terminal 30 is established after the interruption of the communication caused by the restart, the manager 104 determines whether the identification information on the remote terminal 30 having established the communication is identical to the identification information on the remote terminal 30 associated with the error information. If the two pieces of the identification information are identical to each other, the manager 104 transmits the error information to the remote terminal 30 having established the communication. In contrast, if the two pieces of the identification information are not identical to each other, the manager 104 deletes the error information from the database.

The display controller 105 performs control to cause the display 16 (see FIG. 2) to display a variety of information. For example, the display controller 105 performs control to cause an operation screen of the image processing apparatus 10 to be displayed.

The transmission controller 106 performs control to transmit a variety of information via the communication unit 14 (see FIG. 2). Specifically, the transmission controller 106 performs control to transmit the variety of information to the remote terminal 30 and the outside. For example, if the communication with the remote terminal 30 is established again after the interruption of the communication with the remote terminal 30 caused by the restart of the image processing apparatus 10, the transmission controller 106 performs control to transmit the error information stored in the database to the remote terminal 30.

If multiple pieces of the error information are stored in the database, the transmission controller 106 performs control to transmit to the remote terminal 30 the error information that is determined as being a target to be transmitted in response to the priority associated with each piece of the error information. If no error information is stored in the error DB 131, the transmission controller 106 performs control to transmit to the remote terminal 30 information indicating that the power supply of the image processing apparatus 10 is force-disconnected. The phrase “the power supply is force-disconnected” not only refers to a simple on/off operation of the power supply of the image processing apparatus 10 but also refers to the case in which a power plug is pulled out or an unexpected power down occurs.

### Functional Configuration of Controller in Remote Terminal

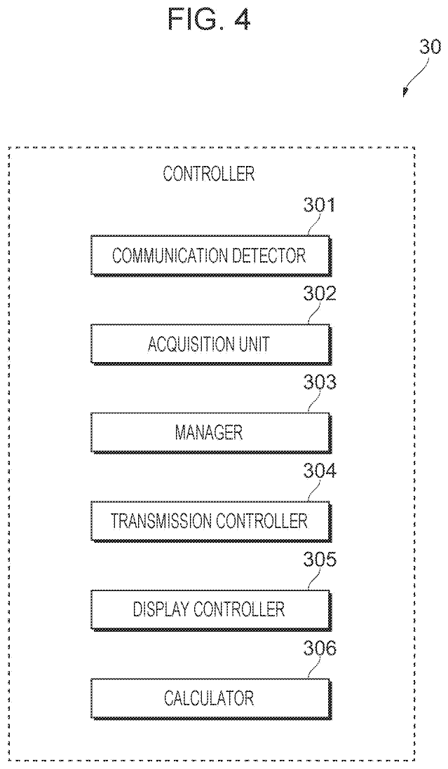

FIG. 4 illustrates an example of a functional configuration of the controller in the remote terminal 30. The controller in the remote terminal 30 includes a communication detector 301, acquisition unit 302, manager 303, transmission controller 304, display controller 305 and calculator 306.

Upon detecting an interruption of the communication with the image processing apparatus 10, the communication detector 301 performs the connectivity verification of the communication with the image processing apparatus 10. The connectivity verification of the communication may be performed by verifying a communication path using a ping command. When time of the connectivity verification of the communication with the image processing apparatus 10 exceeds a predetermined time, the communication detector 301 ends the connectivity verification. As a result of the connectivity verification, the communication detector 301 detects the re-establishment of the communication with the image processing apparatus 10.

The acquisition unit 302 acquires a variety of information. For example, the acquisition unit 302 acquires input information in response to an input operation on the operation unit. For example, the acquisition unit 302 acquires a variety of information transmitted from the image processing apparatus 10 and the outside. Information transmitted from the image processing apparatus 10 out of the information acquired by the acquisition unit 302 includes, for example, error information and information indicating that the power supply of the remote terminal 30 is force-disconnected.

The manager 303 stores a variety of information on the storage and manages the stored information. For example, the manager 303 stores and manages the error information transmitted from the image processing apparatus 10. The manager 303 also stores and manages log information about time used to reconnect the remote terminal 30 to the image processing apparatus 10.

The transmission controller 304 performs control to transmit a variety of information via the communication unit. Specifically, the transmission controller 304 performs control to transmit the variety of information to the image processing apparatus 10 and the outside. For example, the transmission controller 304 performs control to transmit the input information acquired by the acquisition unit 302 to the image processing apparatus 10. When the established communication is detected by the communication detector 301, the transmission controller 304 performs control to transmit information indicating the established communication to the image processing apparatus 10.

The display controller 305 performs control to cause the display to display a variety of information. For example, the display controller 305 performs control to cause the display to display estimated time calculated by the calculator 306.

While the connectivity verification of the communication is performed by the communication detector 301, the calculator 306 calculates the estimated time until the communication is established again. For example, based on the log information on the time used for the reconnection and stored on the storage, the calculator 306 calculates the estimated time until the communication with the image processing apparatus 10 is established.

### Process Flow

### Process Flow of Image Processing Apparatus

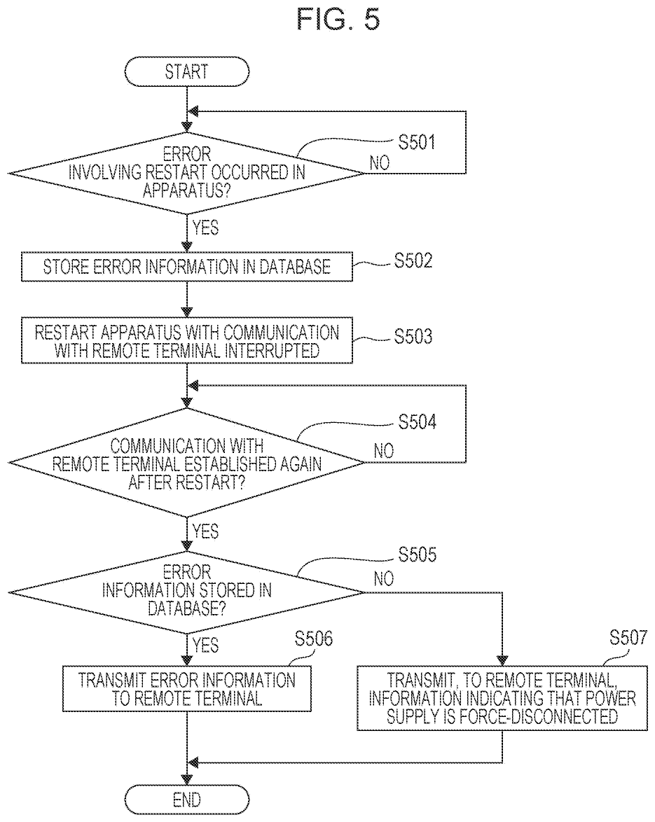

FIG. 5 is a flowchart illustrating an entire process flow of the image processing apparatus 10.

If an error involving a restart of the image processing apparatus 10 remotely operated by the remote terminal 30 having established communication occurs (yes path in step S501), the image processing apparatus 10 stores the error information including a cause of the error in the database (step S502). If any error involving the restart of the image processing apparatus 10 does not occur (no path in step S501), the image processing apparatus 10 iterates the determination operation in step S501 until an error involving the restart of the image processing apparatus 10 has occurred.

The image processing apparatus 10 interrupts the communication with the remote terminal 30 and restarts itself (step S503). If the communication with the remote terminal 30 is established again after the restart (yes path in step S504), the image processing apparatus 10 proceeds to a determination operation in step S505. If the communication with the remote terminal 30 is not established (no path in step S504), the image processing apparatus 10 iterates the determination operation in step S504 until the communication with the remote terminal 30 has been established.

If the error information is stored in the database (yes path in step S505), the image processing apparatus 10 transmits the error information to the remote terminal 30 (step S506). In contrast, if no error information is stored in the database (no path in step S505), the image processing apparatus 10 transmits to the remote terminal 30 information indicating that the power supply of the image processing apparatus 10 is force-disconnected (step S507).

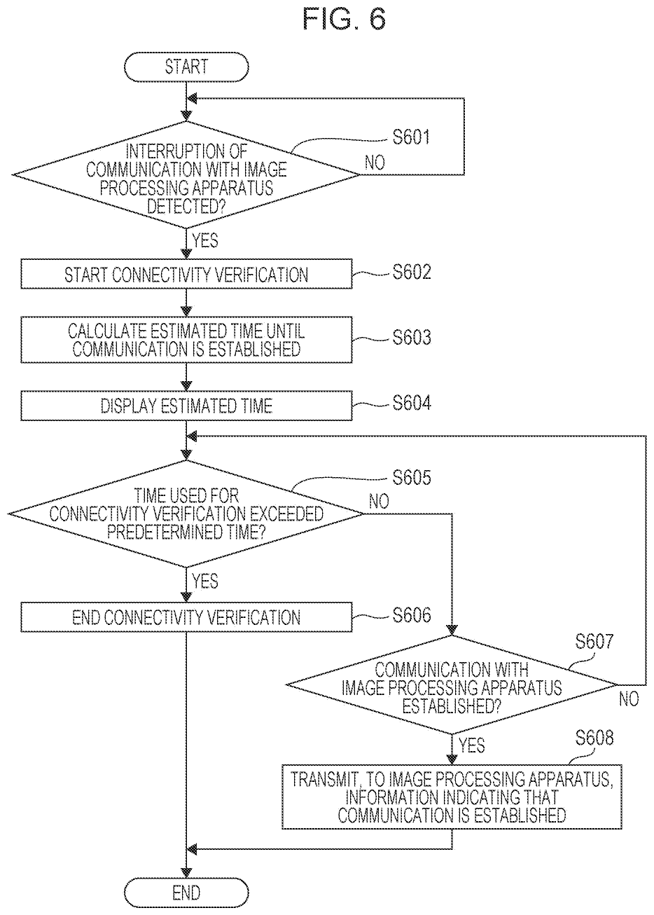

FIG. 6 is a flowchart illustrating an entire process flow of the remote terminal 30. Upon detecting the interruption of the communication with the image processing apparatus 10 (yes path in step S601), the remote terminal 30 starts the connectivity verification of the communication with the image processing apparatus 10 (step S602). In contrast, if the interruption of the communication with the image processing apparatus 10 is not detected (no path in step S601), the remote terminal 30 iterates the determination operation in step S601 until the interruption of the communication with the image processing apparatus 10 has been detected.

While the connectivity verification of the communication with the image processing apparatus 10 is performed, the remote terminal 30 calculates the estimated time until the communication is established again (step S603) and displays the calculated estimated time (step S604). When the time of the connectivity verification of the communication with the image processing apparatus 10 exceeds a predetermined time (yes path in step S605), the remote terminal 30 ends the connectivity verification (step S606). In contrast, if the time of the connectivity verification does not exceed the predetermined time (no path in step S605), the remote terminal 30 continues the connectivity verification and proceeds to a determination operation in step S607.

If the communication with the image processing apparatus 10 is established again as a result of the connectivity verification (yes path in step S607), the remote terminal 30 transmits to the image processing apparatus 10 information indicating that the communication has been established (step S608). In contrast, if the communication with the image processing apparatus 10 is not established (no path in step S607), the remote terminal 30 returns to the determination operation in step S605.

### Specific Examples

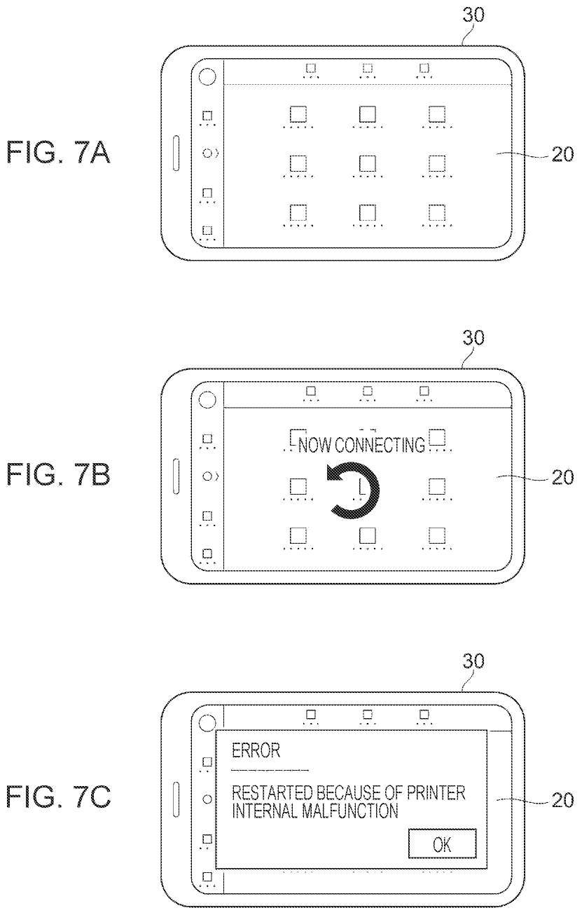

FIGS. 7A through 7C illustrate specific examples of information displayed on the display of the remote terminal 30. FIG. 7A illustrates a specific example of the information displayed on the display of the remote terminal 30 when the image processing apparatus 10 is remotely operated. FIG. 7B illustrates a specific example of the information displayed on the display of the remote terminal 30 when a connectivity is verified by the remote terminal 30 with the communication with the image processing apparatus 10 interrupted. FIG. 7C illustrates a specific example of the error information that is transmitted from the image processing apparatus 10 to the remote terminal 30 when the communication is established again after the interruption of the communication.

Referring to FIG. 7A, the display of the remote terminal 30 remotely operating the image processing apparatus 10 shares an operation screen 20 of the image processing apparatus 10. Specifically, when an input operation is performed on the operation screen 20 of the image processing apparatus 10 that is also displayed on the display of the remote terminal 30, a variety of operations are performed on the image processing apparatus 10 based on the assumption that the input operation is directly performed on the operation screen 20 of the image processing apparatus 10.

If the communication is interrupted during a remote operation, the remote terminal 30 starts the connectivity verification of the communication and the display of the remote terminal 30 displays a screen indicating that reconnecting is in progress as illustrated in FIG. 7B. If the communication is established again between the image processing apparatus 10 and remote terminal 30, the image processing apparatus 10 transmits the error information to the remote terminal 30. Contents of the error information are displayed on the display of the remote terminal 30. FIG. 7C illustrates a specific example of the contents of the error information transmitted from the image processing apparatus 10. FIG. 7C illustrates as the error information a message reading “Restarted because of printer internal malfunction.”

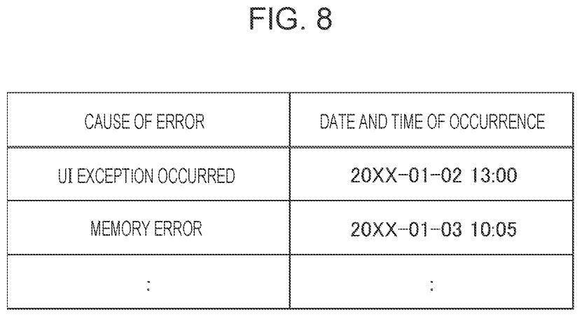

FIG. 8 illustrates a specific example of the error information held in the error DB 131 stored on the storage 13 of the image processing apparatus 10.

The error DB 131 stores as the error information that associates the cause of each error with the date and time of the occurrence of the error. For example, FIG. 8 illustrates the error information where the cause of the error is “UI exception occurred” and the date and time of the occurrence is “20XX-01-02 13:00” and the error information where the cause of the error is “memory error” and the date and time of the occurrence is “20XX-01-03 10:05.” FIG. 8 illustrates examples of the error information and information other than the cause of the error and the date and time of the occurrence may be associated with the error.

### Other Exemplary Embodiments

The exemplary embodiment has been described. The disclosure is not limited to the exemplary embodiment described above. The effects of the disclosure are not limited to those described with reference to the exemplary embodiment. For example, the configuration of the information processing system 1 in FIG. 1 and the hardware configuration of the image processing apparatus 10 in FIG. 2 have been described for exemplary purposes only and the disclosure is not limited to the configurations described herein. The functional configuration of the image processing apparatus 10 in FIG. 3 and the functional configuration of the remote terminal 30 in FIG. 4 have been described for exemplary purposes only and the disclosure is not limited to the functional configurations described herein. The information processing system 1 in FIG. 1 may provide the functions implementing all the processes described above. The functional configurations performing the functions are not limited to the function configurations in FIGS. 3 and 4.

The order of the steps in the process of the image processing apparatus 10 in FIG. 5 and the order of the steps in the process of the remote terminal 30 in FIG. 6 have been described for exemplary purposes only and the disclosure is not limited to the orders of the steps described herein. The processes may be performed in time-series sequence in accordance with the orders of the steps. Alternatively, the steps of each process may be performed in parallel or individually in place of the time-series sequence. FIGS. 7A through 7C and 8 illustrate examples only and the disclosure is not limited to the examples.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system including:
one or more processors configured to:
   if an error involving a restart occurs on an image processing apparatus remotely operated by a terminal having established communication, store error information including a cause of the error in a memory region before the restart; and
   if the communication is established again after an interruption of the communication caused by the restart, notify the terminal of the error information stored in the memory region.
      (((2)))

In the information processing system according to (((1))), the one or more processors are configured to, if the communication is established after a connectivity verification of the communication is made in response to an interruption of the communication detected by the terminal, notify the terminal of the error information stored in the memory region.

(((3)))

In the information processing system according to (((2))), the one or more processors are configured to end the connectivity verification of the communication if time used to perform the connectivity verification of the communication exceeds a predetermined time duration.

(((4)))

In the information processing system according to (((3))), the one or more processors are configured to, while the connectivity verification of the communication is being performed, display on the terminal an estimated time until the communication is established.

(((5)))

In the information processing system according to (((4))), the estimated time is based on an actual value of time until the communication is established.

(((6)))

In the information processing system according to (((2))), the one or more processors are configured to, if the error information is not stored in the memory region when the communication is established, notify the terminal that a power supply of the image processing apparatus is force-disconnected.

(((7)))

In the information processing system according to one of (((1))) through (((6))), the one or more processors are configured to:
if multiple errors occur while the communication is interrupted, store in the memory region multiple pieces of the error information respectively on the errors before the restart; and
if the communication is established again after the interruption of the communication caused by the restart, notify the terminal of the pieces of the error information on the errors stored in the memory region.
   (((8)))

In the information processing system according to (((7))), the one or more processors are configured to:
store the pieces of the error information in the memory region with the pieces of the error information respectively associated with priorities; and
in accordance with the priorities, determine the error information that is to be notified to the terminal.
   (((9)))

In the information processing system according to one of (((1))) through (((8))), the one or more processors are configured to, at a predetermined timing, delete or move from the memory region the error information stored in the memory region.

(((10)))

In the information processing system according to (((9))), the one or more processors are configured to delete the error information from the memory region at the predetermined timing that is any timing after the error information stored in the memory region is notified to the terminal.

(((11))

In the information processing system according to (((9))), the one or more processors are configured to, at the predetermined timing that is any timing after the error information stored in the memory region exceeds one of a predetermined storage period, a predetermined number of storage items and a predetermined amount of storage, delete an excess portion of the error information from the memory region.

(((12)))

In the information processing system according to (((9))), the one or more processors are configured to, at the predetermined timing that is any timing after storage of multiple pieces of the error information in the memory region is confirmed, move the pieces of the error information except a piece of the error information closest to a date and time of occurrence of the error to a second memory region different from the memory region.

(((13)))

In the information processing system according to (((9))), the one or more processors are configured to:
store the error information in the memory region with the error information associated with identification information uniquely identifying the terminal; and
if the communication is established after the interruption of the communication caused by the restart, delete the error information from the memory region at the predetermined timing that is any timing after the terminal identified by the identification information and having established the communication is determined as being different from the terminal associated with the error information.
   (((14)))

In the information processing system according to (((9))), the one or more processors are configured to:
store the error information in the memory region with the error information associated with identification information uniquely identifying the terminal; and
if the communication is established after the interruption of the communication caused by the restart, notify the terminal having established the communication of the error information if the terminal identified by the identification information and having established the communication is identical to the terminal associated with the error information.
   (((15)))

A program causing a computer to execute a process, the process including:
if an error involving a restart occurs on an image processing apparatus remotely operated by a terminal having established communication, storing error information including a cause of the error in a memory region before the restart; and
if the communication is established again after an interruption of the communication caused by the restart, notifying the terminal of the error information stored in the memory region.

What is claimed is:

1. An information processing system comprising:
one or more processors configured to:
if an error involving a restart occurs on an image processing apparatus remotely operated by a terminal having established communication, store error information including a cause of the error in a memory region before the restart; and
if the communication is established again after an interruption of the communication caused by the restart, notify the terminal of the error information stored in the memory region.

2. The information processing system according to claim 1, wherein the one or more processors are configured to, if the communication is established after a connectivity verification of the communication is made in response to an interruption of the communication detected by the terminal, notify the terminal of the error information stored in the memory region.

3. The information processing system according to claim 2, wherein the one or more processors are configured to end the connectivity verification of the communication if time used to perform the connectivity verification of the communication exceeds a predetermined time duration.

4. The information processing system according to claim 3, wherein the one or more processors are configured to, while the connectivity verification of the communication is being performed, display on the terminal an estimated time until the communication is established.

5. The information processing system according to claim 4, wherein the estimated time is based on an actual value of time until the communication is established.

6. The information processing system according to claim 2, wherein the one or more processors are configured to, if the error information is not stored in the memory region when the communication is established, notify the terminal that a power supply of the image processing apparatus is force-disconnected.

7. The information processing system according to claim 1, wherein the one or more processors are configured to:
if a plurality of the errors occur while the communication is interrupted, store in the memory region a plurality of pieces of the error information respectively on the errors before the restart; and
if the communication is established again after the interruption of the communication caused by the restart, notify the terminal of the pieces of the error information on the errors stored in the memory region.

8. The information processing system according to claim 7, wherein the one or more processors are configured to:
store the pieces of the error information in the memory region with the pieces of the error information respectively associated with priorities; and
in accordance with the priorities, determine the error information that is to be notified to the terminal.

9. The information processing system according to claim 1, wherein the one or more processors are configured to, at a predetermined timing, delete or move from the memory region the error information stored in the memory region.

10. The information processing system according to claim 9, wherein the one or more processors are configured to delete the error information from the memory region at the predetermined timing that is any timing after the error information stored in the memory region is notified to the terminal.

11. The information processing system according to claim 9, wherein the one or more processors are configured to, at the predetermined timing that is any timing after the error information stored in the memory region exceeds one of a predetermined storage period, a predetermined number of storage items and a predetermined amount of storage, delete an excess portion of the error information from the memory region.

12. The information processing system according to claim 9, wherein the one or more processors are configured to, at the predetermined timing that is any timing after storage of a plurality of pieces of the error information in the memory region is confirmed, move the pieces of the error information except a piece of the error information closest to a date and time of occurrence of the error to a second memory region different from the memory region.

13. The information processing system according to claim 9, wherein the one or more processors are configured to:
store the error information in the memory region with the error information associated with identification information uniquely identifying the terminal; and
if the communication is established after the interruption of the communication caused by the restart, delete the error information from the memory region at the predetermined timing that is any timing after the terminal identified by the identification information and having established the communication is determined as being different from the terminal associated with the error information.

14. The information processing system according to claim 9, wherein the one or more processors are configured to:
store the error information in the memory region with the error information associated with identification information uniquely identifying the terminal; and
if the communication is established after the interruption of the communication caused by the restart, notify the terminal having established the communication of the error information if the terminal identified by the identification information and having established the communication is identical to the terminal associated with the error information.

15. A non-transitory computer readable medium storing a program causing a computer to execute a process, the process comprising:
if an error involving a restart occurs on an image processing apparatus remotely operated by a terminal having established communication, storing error information including a cause of the error in a memory region before the restart; and
if the communication is established again after an interruption of the communication caused by the restart, notifying the terminal of the error information stored in the memory region.

16. An information processing method comprising:
if an error involving a restart occurs on an image processing apparatus remotely operated by a terminal having established communication, storing error information including a cause of the error in a memory region before the restart; and
if the communication is established again after an interruption of the communication caused by the restart, notifying the terminal of the error information stored in the memory region.
